(19) United States
(12) Patent Application Publication
(10) Pub. No.: US 2013/0074346 A1
(43) Pub. Date: Mar. 28, 2013

(54) EDGE BAND CUTTING DEVICE

(71) Applicant: Chin-Chi LIN, Taichung City (TW)

(72) Inventor: Chin-Chi LIN, Taichung City (TW)

(21) Appl. No.: 13/240,950

(22) Filed: Sep. 22, 2011

(51) Int. Cl. B26B 27/00

(52) U.S. Cl. 30/241

(57) ABSTRACT

An edge band cutting device comprises: a fixed unit including a base plate having an opening, and a pressing plate connected to and perpendicular to the base plate; a moving unit including a movable plate movable on the base plate; a cutter unit including a main cutter disposed on the base plate, and an auxiliary cutter disposed on the movable plate, a space between the main and auxiliary cutters being aligned with the opening so as to allow an edge band to extend through the opening and between the main and auxiliary cutters; and an adjusting unit including an adjusting member disposed on the fixed unit, movable to contact the main cutter, and having an abutting surface facing away from the main cutter for abutting against a start end of the edge band.

### BACKGROUND OF THE INVENTION

1. Field of the Invention

This invention relates to a cutting device, and more particularly to an edge band cutting device.

2. Description of the Related Art

Referring to FIG. 1, a conventional edge band cutting device 1 includes a pressing plate 11, an upright plate 12 connected to the pressing plate 11 and having a penetration hole 121, a movable plate 13 movable on the upright plate 12, a main cutter 14 disposed on the upright plate 12, an auxiliary cutter 15 disposed on the movable plate 13, and a handle 16 connected pivotally to the upright plate 12 and operable for driving the movable plate 13.

In a process for adhering an edge band 100 to a plank 103, such as a table top, after the edge band 100 is extended over the full length of an outer periphery of the plank 103, the edge band cutting device 1 is used to cut the edge band 100. To cut the edge band 100, a trailing end portion of the edge band 100 is first passed through the penetration hole 121. Next, a back surface of the main cutter 14 is moved into contact with a start end 101 of the edge band 100. Finally, the handle 16 is operated to move the movable plate 13 on the upright plate 12 so as to move the auxiliary cutter 15 toward the main cutter 14 for cutting the edge band 100.

However, since the main cutter 14 has a width, the cut point 102 of the edge band 100 is far away from the plank 103. As such, the length (L1) of a segment of the edge band 100 between the cut point 102 and an adhered terminal end 104 is longer than the distance (L2) between the start end 101 and the adhered terminal end 104, thereby resulting in a need for further cutting operation performed on the trailing end portion of the edge band 100.

With additional reference to FIGS. 2 and 3, if the cut portion of the edge band 100 is located at a corner of the plank 103, a positioning rod 17 can be mounted to the pressing plate 11 by a bolt, to abut against a side of the plank 103 for facilitating positioning of the pressing plate 11 relative to the plank 103.

However, it is troublesome to mount and remove the positioning rod 17.

### SUMMARY OF THE INVENTION

The object of this invention is to provide an edge band cutting device capable of adjusting the cut length of an edge band.

According to this invention, an edge band cutting device comprises: a fixed unit including a base plate having an opening, and a pressing plate connected to and perpendicular to the base plate; a moving unit including a movable plate movable on the base plate; a cutter unit including a main cutter disposed on the base plate, and an auxiliary cutter disposed on the movable plate, a space between the main and auxiliary cutters being aligned with the opening; and an adjusting unit including an adjusting member disposed on the fixed unit, movable to contact the main cutter, and having an abutting surface facing away from the main cutter for abutting against a start end of an edge band.

By moving the adjusting member relative to the main cutter, the cut length of the edge band can be adjusted to allow the start end and a cut end of the edge band to contact intimately with each other.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a top view of a conventional edge band cutting device when cutting an edge band at a side of a plank;

FIGS. 2 and 3 are top and side views of the conventional edge band cutting device, respectively, when cutting the edge band at a corner of the plank;

FIG. 4 is a perspective view of the preferred embodiment of an edge band cutting device according to this invention, illustrating that an adjusting member is removed from a main cutter;

FIG. 5 is a top view of the preferred embodiment, illustrating that the adjusting member abuts against the main cutter;

FIG. 6 is a partly sectional side view of the preferred embodiment, illustrating that the adjusting member abuts against the main cutter;

FIG. 7 is a view similar to FIG. 6 but illustrating that a positioning rod is retracted into a sleeve;

FIG. 8 is a partly sectional schematic view of the preferred embodiment, illustrating that an auxiliary cutter is spaced apart from the main cutter;

FIG. 9 is a view similar to FIG. 8, but illustrating that the auxiliary cutter comes into contact with the main cutter; and

FIG. 10 is a top view of the preferred embodiment, when cutting an edge band at a corner of a plank.

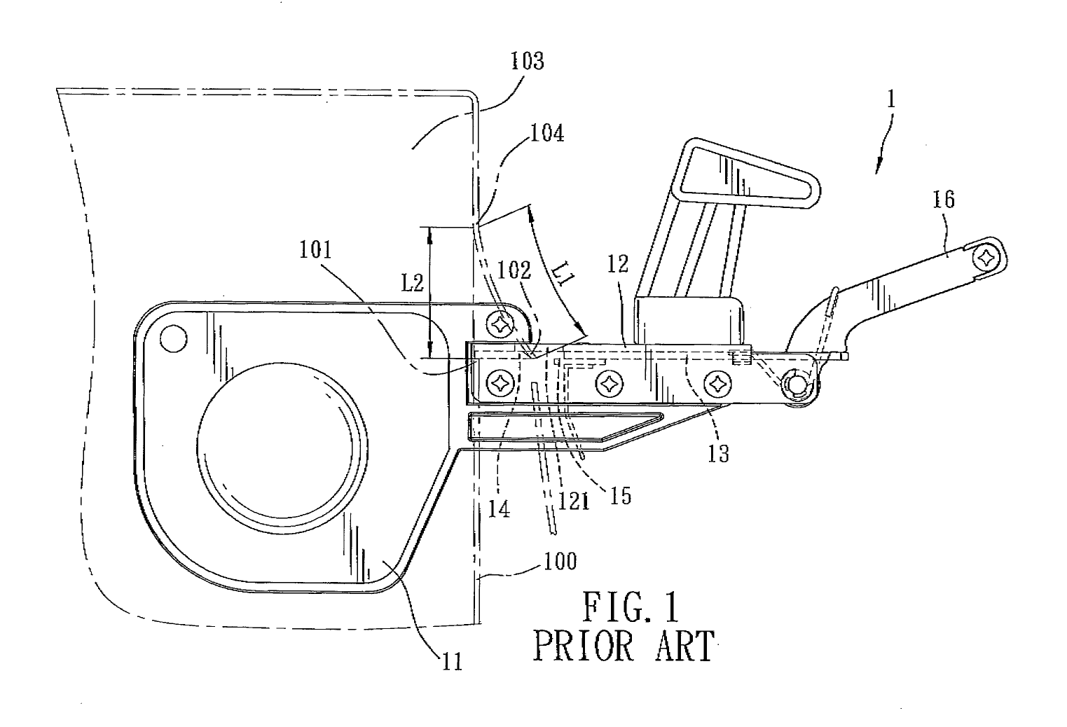

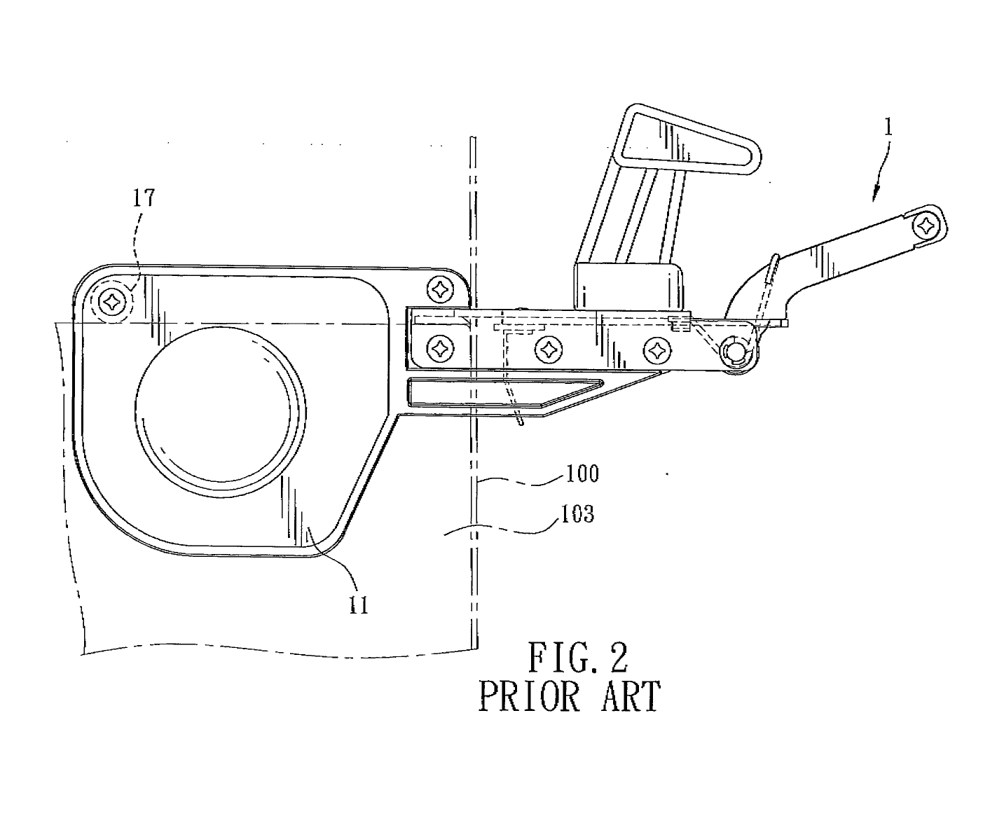

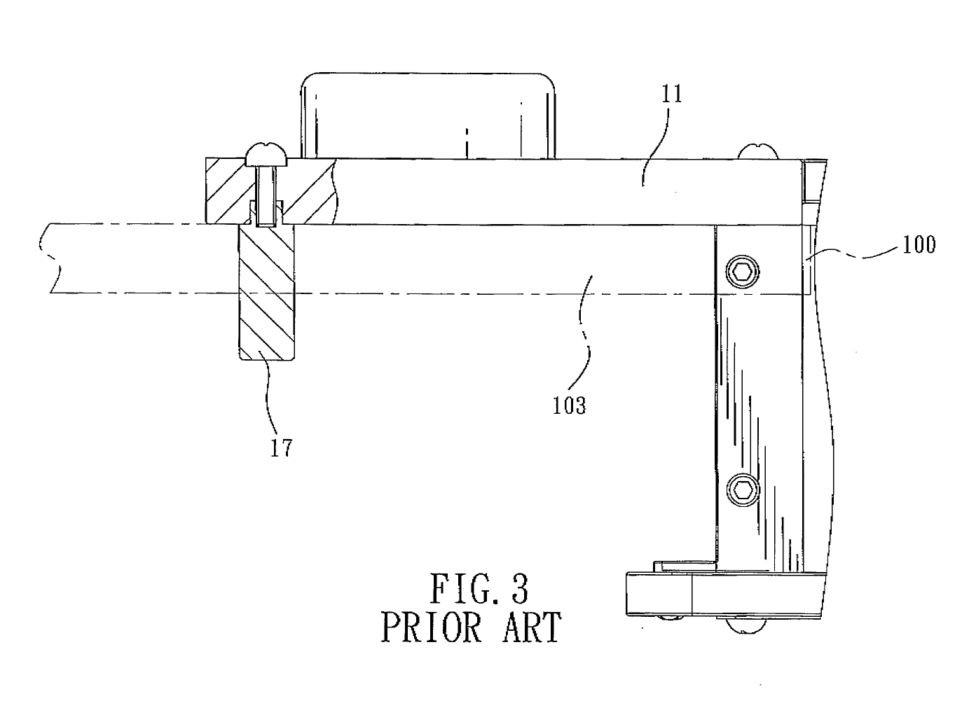

### DETAILED DESCRIPTION OF THE PREFERRED EMBODIMENT

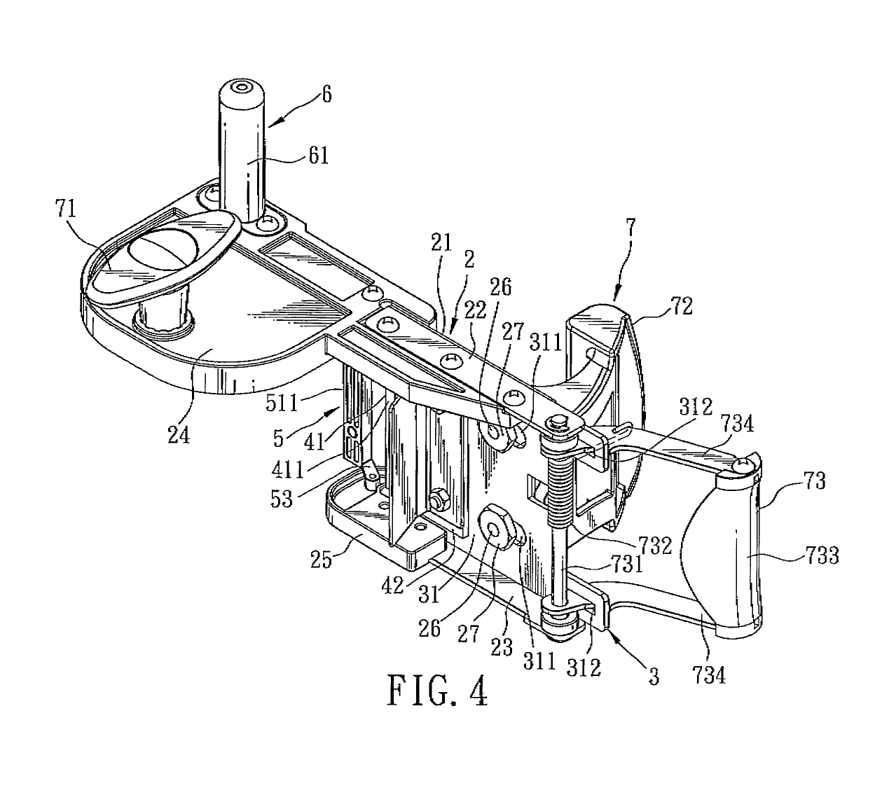

Referring to FIGS. 4, 5, and 6, the preferred embodiment of an edge band cutting device according to this invention includes a fixed unit 2, a moving unit 3, a cutter unit 4, an adjusting unit 5, a positioning unit 6, and a handle unit 7.

The fixed unit 2 includes an upright base plate 2 having an opening 211, a top plate 22 connected to the base plate 2, a main bottom plate 23 connected to the base plate 2 and disposed under the top plate 22, a pressing plate 24 disposed on the top plate 22 and perpendicular to the base plate 21, and an auxiliary bottom plate 25 connected to the main bottom plate 23. The pressing plate 24 has a penetration hole 241.

The moving unit 3 includes a movable plate 31 movable on the base plate 21 and disposed between the top plate 22 and the main bottom plate 23.

In this embodiment, the fixed unit 2 further includes two guide rods 26 extending from the base plate 21, and two stop nuts 27 disposed respectively on distal ends of the guide rods 26. The movable plate 31 has two slide slots 311 for receiving respectively and movably the guide rods 26, and two through holes 312.

The cutter unit 4 includes a main cutter 41 disposed on the base plate 21 and having a back surface 411 facing away from the base plate 21, and an auxiliary cutter 42 disposed on the movable plate 31. A space between the main and auxiliary cutters 41, 42 is aligned with the opening 211.

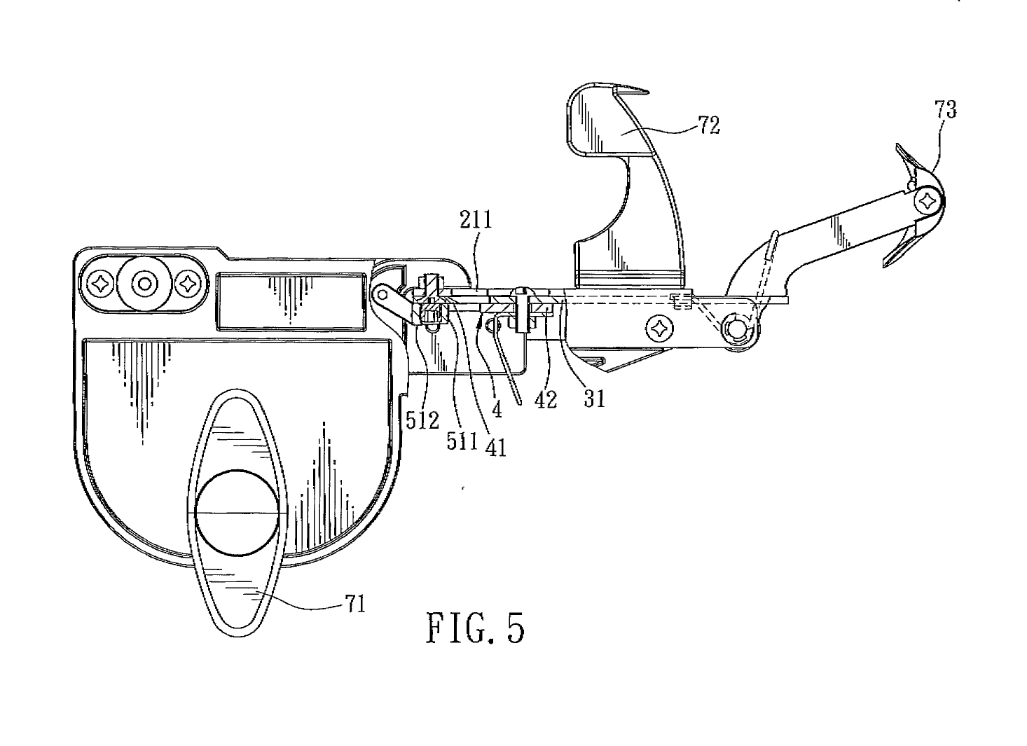

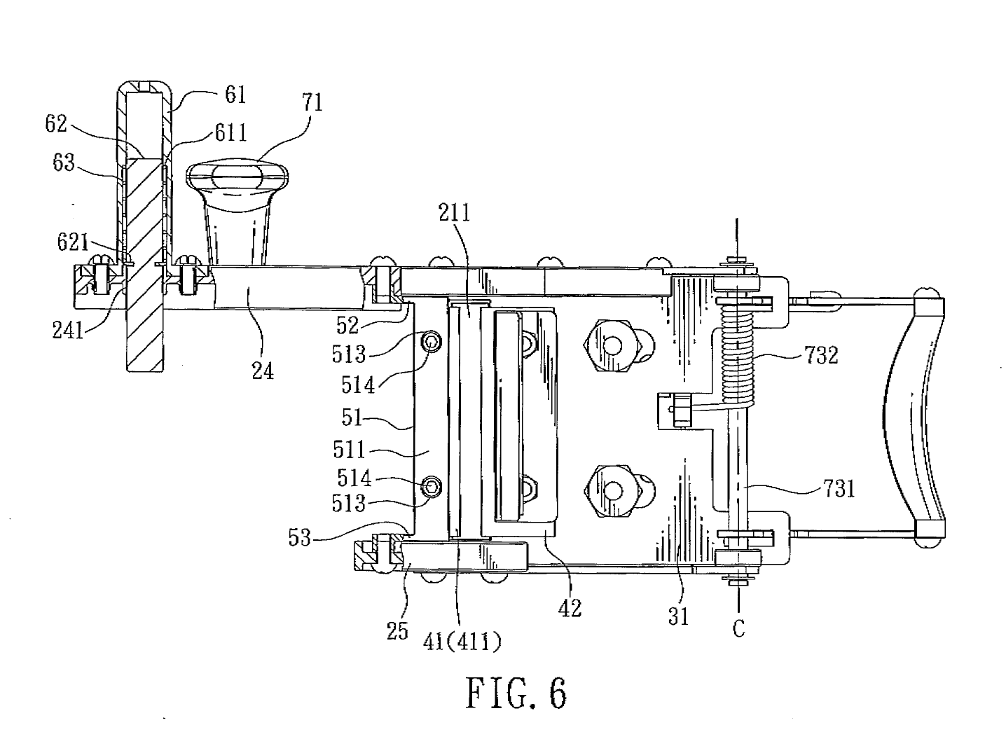

The adjusting unit 5 includes an adjusting member 51 movable on the fixed unit 3 toward and away from the back surface 411 of the main cutter 41, and two swing arms 52, 53 extending from the adjusting member 51 and connected respectively and pivotally to the pressing plate 24 and the auxiliary bottom plate 25. The adjusting member 51 can be adjusted to contact the main cutter 41, as shown in FIGS. 5 and 6, or separate from the main cutter 41, as shown in FIG. 4.

The adjusting member 51 has an adjusting plate 511, two threaded holes 513 formed through the adjusting plate 511, and two adjustment bolts 514 engaging respectively the threaded holes 513. The adjusting plate 511 has an abutting surface 512 (i.e., a side surface facing away from the main cutter 41. The adjustment bolts 514 project from the adjusting plate 511 to abut against the main cutter 41, and are adjustable to change the distance between the abutting surface 512 and the main cutter 41.

The positioning unit 6 includes a sleeve 61 disposed fixedly on the pressing plate 24 and covering the penetration hole 291, a positioning rod 62 disposed movably within the sleeve 61 and extending through the penetration hole 241, and a spring 63 disposed between the sleeve 61 and the positioning rod 62 for biasing the positioning rod 62 to project downwardly from the pressing plate 24 through the penetration hole 241. In this embodiment, the spring 63 is a compression spring, and has one end abutting against a shoulder 611 (see FIG. 6) of the sleeve 61, and the other end abutting against a C-shaped retaining ring 621 of the positioning rod 62.

The handle unit 7 includes a first fixed handle 71 disposed fixedly on the pressing plate 24, a second fixed handle 72 disposed fixedly on the base plate 21, and an operating handle 73 connected pivotally to the base plate 21.

The operating handle 73 includes a shaft rod 731 extending between the top plate 22 and the main bottom plate 23 along an axis (C) (see FIG. 6), a torsion spring 732 sleeved on the shaft rod 731, a grip portion 733, and two levers 734 extending respectively through the through holes 312 and connected between the grip portion 733 and the shaft rod 731. The torsion spring 732 has two ends abutting respectively against the base plate 21 and one of the levers 734 for biasing the grip portion 733 to its original position.

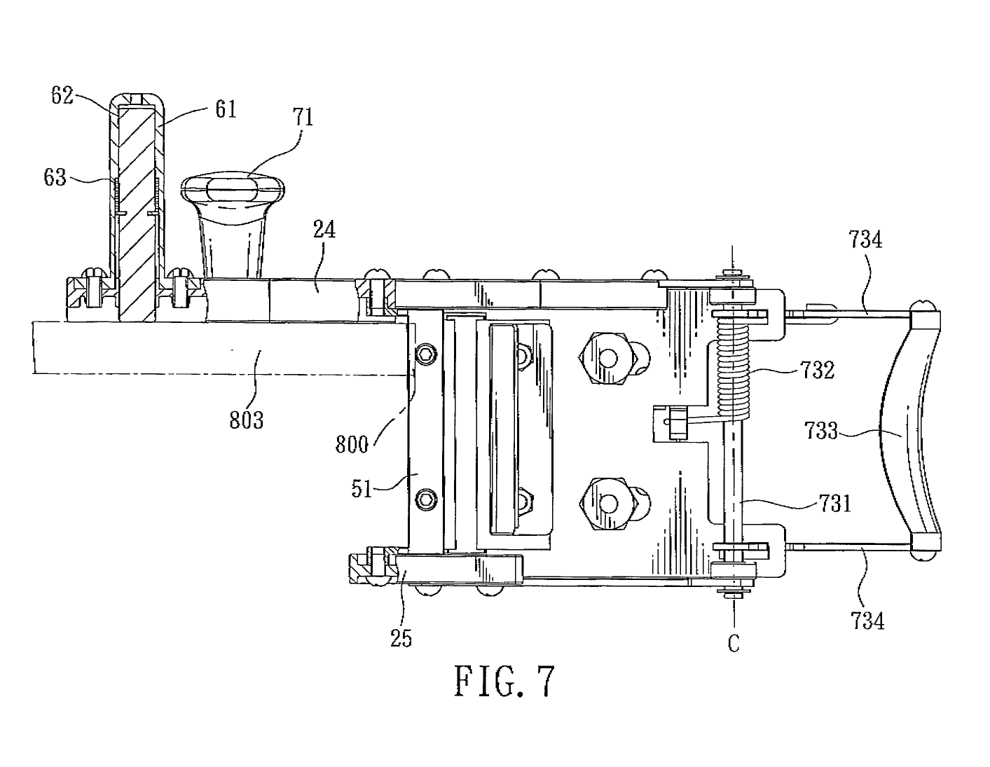

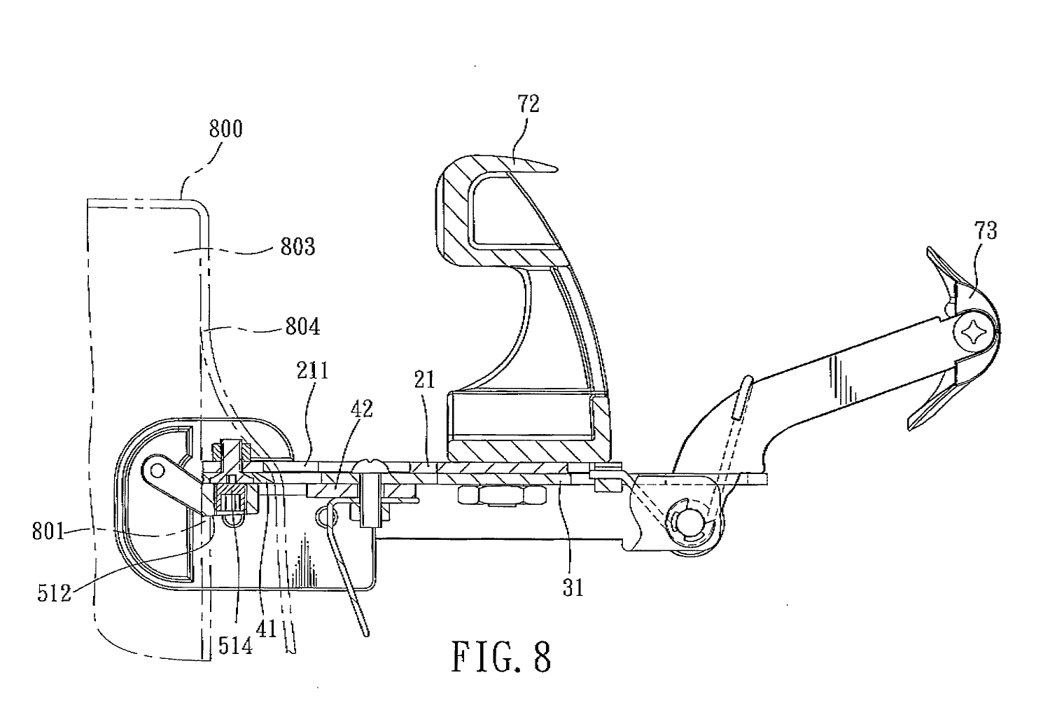

With particular reference to FIGS. 4, 7, and 8, when an edge band 800 is adhered to a plank 803 (such as a table top) from a start end 801, and when it is extended over the full length of an outer periphery of the plank 803, a non-adhered trailing end portion of the edge band 800 is passed through the opening 211 in the base plate 21. At the same time, the pressing plate 24 is placed on the plank 803 so that the positioning rod 62 is pushed and retracted into the sleeve 61. Subsequently, the adjusting member 51 is adjusted to abut against the main cutter 41, and is moved to allow the abutting surface 512 to contact the start end 801 of the edge band 800. At this time, the operating handle 73 can be rotated toward the second fixed handle 72 to move the movable plate 31 and the auxiliary cutter 42 toward the main cutter 41 for cutting the edge band 800.

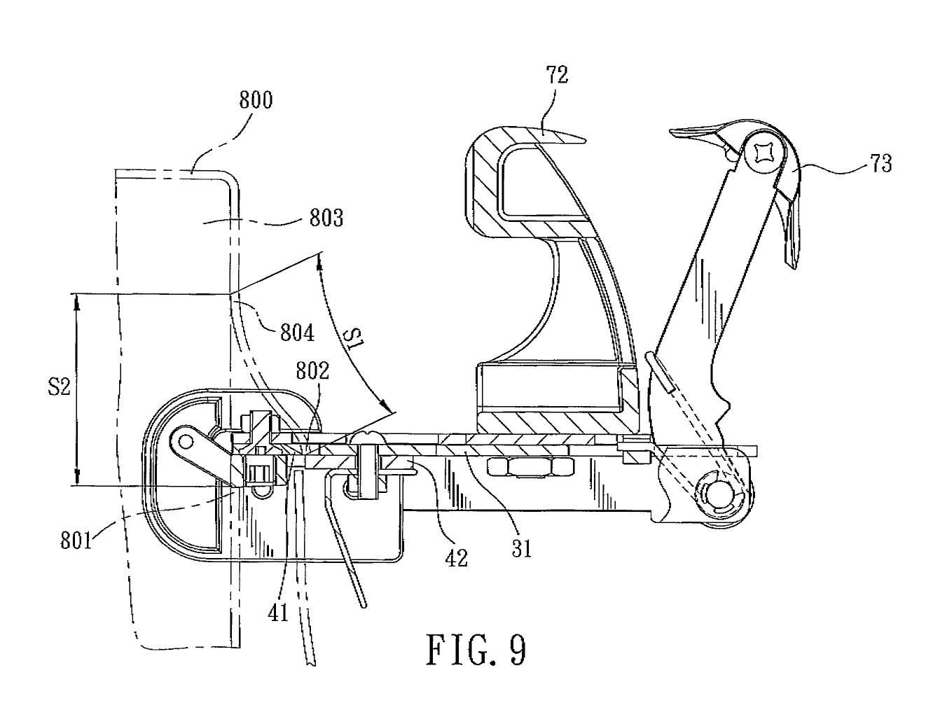

In this manner, with further reference to FIG. 9, the length (S1) of a segment of the edge band 800 between a cut end 802 and an adhered terminal end 804 can be controlled to be equal to the distance (S2) between the start end 801 and the adhered terminal end 804 so that, when the segment is adhered to the plank 800, the cut end 802 can be brought into intimate contact with the start end 801 without further cutting operation performed on the segment.

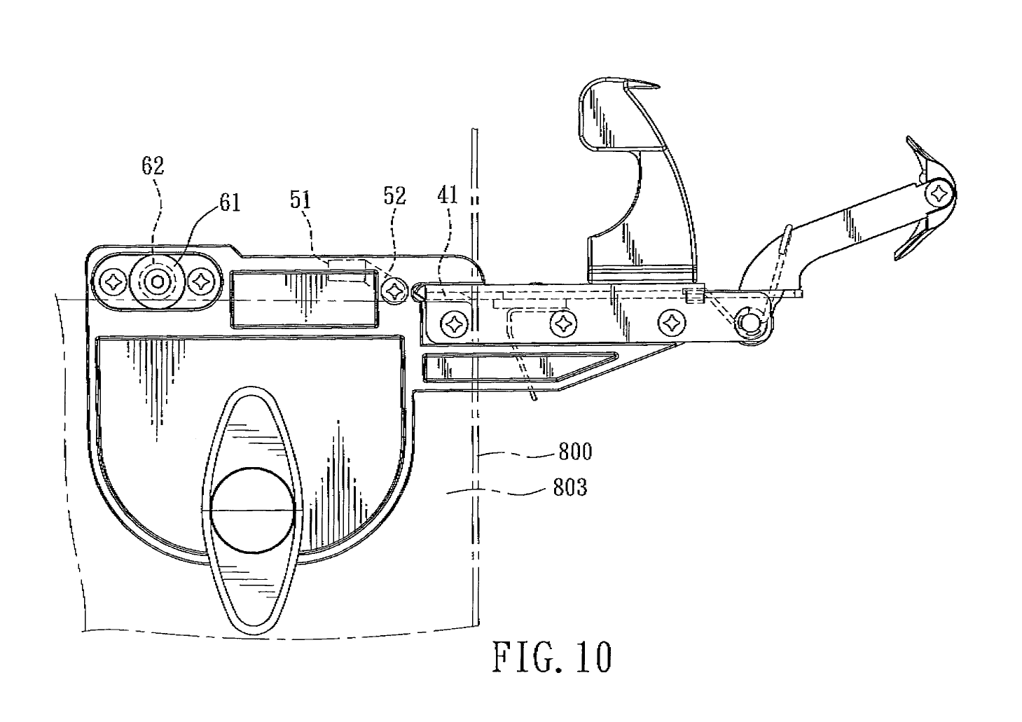

With particular reference to FIGS. 4, 6, and 10, when the edge band 800 is cut at a corner thereof, the sleeve 61 is removed from the plank 803 to allow the positioning rod 62 to be biased by the spring 63 to project downwardly from the pressing plate 24. Hence, the positioning rod 62 can be moved into contact with a side of the plank 800 for facilitating positioning, of the pressing plate 24 relative to the plank 800, and the swing arms 52, 53 can be rotated relative to the fixed unit 3 to separate the adjusting member 51 from the main cutter 41 to thereby allow for subsequent cutting operation of the main cutter 41 on the edge band 800 at the corner. Extensibility and retractability of the positioning rod 62 result in convenience during use of the edge band cutting device.

With this invention thus explained, it is apparent that numerous modifications and variations can be made without departing from the scope and spirit of this invention. It is therefore intended that this invention be limited only as indicated by the appended claims.

1. An edge band cutting device comprising:
a fixed unit including a base plate having an opening, and a pressing plate connected to and perpendicular to said base plate;
a moving unit including a movable plate movable on said base plate;
a cutter unit including a main cutter disposed on said base plate, and an auxiliary cutter disposed on said movable plate, a space between said main and auxiliary cutters being aligned with said opening; and
an adjusting unit including an adjusting member movable on said fixed unit to contact said main cutter and having an abutting surface facing away from said main cutter.

2. The edge band cutting device as claimed in claim 1, wherein said base plate is upright, and said fixed unit further includes a top plate connected to said base plate, a main bottom plate connected to said base plate and disposed under said top plate, and an auxiliary bottom plate connected to said main bottom plate, said pressing plate being disposed on said top plate.

3. The edge band cutting device as claimed in claim 2, wherein said adjusting unit further includes two swing arms extending from said adjusting member and connected respectively and pivotally to said pressing plate and said auxiliary bottom plate.

4. The edge band cutting device as claimed in claim 3, wherein said adjusting member further has an adjusting plate, at least one threaded hole formed through said adjusting plate, and at least one adjustment bolt engaging said threaded hole and contactable with said main cutter, said adjusting plate having a side surface constituting said abutting surface.

5. The edge band cutting device as claimed in claim 2, further comprising a handle unit that includes a first fixed handle disposed fixedly on said pressing plate, a second fixed handle disposed fixedly on said base plate, and an operating handle connected pivotally to said base plate and operable to move said auxiliary cutter toward said main cutter.

6. The edge band cutting device as claimed in claim 5, wherein said movable plate has two through holes, and said operating handle includes a shaft rod extending between said top plate and said main bottom plate along an axis, a torsion spring sleeved on said shaft rod, a grip portion, and two levers extending respectively through said through holes and connected between said grip portion and said shaft rod, said torsion spring having two ends abutting respectively against said base plate and one of said levers for biasing said grip portion to return to its original position.

7. The edge band cutting device as claimed in claim 1, further comprising a positioning unit, said pressing plate having a penetration hole, said positioning unit including a sleeve disposed on said pressing plate and covering said penetration hole, a positioning rod disposed movably within said sleeve and extending through said penetration hole, and a spring disposed between said sleeve and said positioning rod for biasing said positioning rod to extend outwardly from said pressing plate and said sleeve through said penetration hole.
